(19) United States
(12) Patent Application Publication
(10) Pub. No.: US 2008/0083730 A1
(43) Pub. Date: Apr. 10, 2008

(54) Cooking apparatus with temperature probe and hinged lid

(75) Inventors: Mona Wetter Dolgov, Natick, MA (US); Jeff Kornreich, Milbury, MA (US); Kelly White, Hudson, MA (US); Amy Golino, Westborough, MA (US); Keith Coutu, West Warwick, RI (US); Robert A. Barker, Berlin, MA (US)

Correspondence Address: HOFFMANN & BARON, LLP, 6900 JERICHO TURNPIKE, SYOSSET, NY, 11791, US

(73) Assignee: Sunbeam Products, Inc.

(21) Appl. No.: 11/513,987

(22) Filed: Aug. 31, 2006

(51) Int. Cl. F27D 11/00

(52) U.S. Cl. 219/432; 219/436

(57) ABSTRACT

The invention pertains to a multi-functional cooker having a thermal probe operatively connected to a controller for controlling a heating element in response to a real-time temperature reading from the probe. By controlling the level of heat provided by the heating element in response to real-time temperature readings, optimal comestible flavor may be achieved. The multi-functional cooker also includes a hinged lid for directing fluid on an inner surface of the lid into a cooking vessel of the invention upon opening of the lid.

### FIELD OF THE INVENTION

The present invention relates generally to a cooking apparatus, and more particularly to a slow cooker having a thermal probe cooking mode and a hinged lid.

### BACKGROUND OF THE INVENTION

Cooking apparatus, such as slow cookers, are used for preparing and cooking food and are well known in the art. Typically, a slow cooker consists of a cooking vessel, such as a ceramic or stoneware pot, surrounded by a housing, usually metal, containing a controlled electric heating element. The cooking vessel acts as both a cooking container and a heat reservoir. Many of today's slow cookers have two heat settings, e.g., high and low, and also include removable lids that retain moisture and heat in the cooking vessel while cooking.

Slow cookers involve a cooking process which subjects food to a cooking temperature for relatively long periods of time. In this cooking process, a relatively large cooking time window exists in which the food is sufficiently cooked to be safely eaten and but not over-cooked to the point of being undesdesirable. However, in slow cookers of the prior art, it is difficult to determine when the food has been cooked to achieve optimal flavor. Accordingly, it would be desirable to provide a cooking device that easily allows food to be cooked to an optimal degree.

Slow cookers of the prior art also present difficulties with respect to their lids. For example, after cooking a meal in the slow cooker, the lid is removed. Typically, the lid includes condensation and other comestible matter on its inner surface from the cooking activity. Removal of the lid may cause the condensation and comestible matter on the inner surface of the lid to drip onto the housing, a counter top or table, or possible a floor surface, which is not desirable. Accordingly, it is desirable to provide a cooking apparatus that addresses these difficulties.

### SUMMARY OF THE INVENTION

The invention pertains to a multi-functional cooker having a thermal probe operatively connected to a controller for controlling a heating element in response to a real-time temperature reading from the probe. By controlling the level of heat provided by the heating element in response to real-time temperature readings, optimal comestible flavor may be achieved. The multi-functional cooker also includes a hinged lid for directing fluid on an inner surface of the lid into a cooking vessel of the invention upon opening of the lid.

Various aspects of the assembly relate to a hinged lid cooking apparatus having a temperature probe cooking system. For example, according to one aspect of the invention, a cooking apparatus includes a lid, a housing, a cooking vessel disposed in the housing having a perimeter defining an opening, and a hinge removably coupling the lid to the housing and allowing the lid to be pivoted between a first open position and a second closed position whereupon movement of the lid to the first open position allows fluid on an inner surface of the lid to be directed into said cooking vessel opening.

In another aspect of the invention, a cooking apparatus includes a lid, a thermal probe, a housing, a cooking vessel and a heating element disposed in the housing, and a controller attached to the housing and operably connected to the heating element for controlling operation of the heating element in response to a real-time reading from the thermal probe. The thermal probe is operatively connected to the controller and adapted to be in thermal communication with a comestible disposed in the cooking vessel.

In yet another aspect, a method of cooking a comestible in a multi-mode slow cooker includes providing a thermal probe attached to the slow cooker for a real-time temperature reading of a comestible disposed in a cooking vessel of the slow cooker, selecting a cooking mode for the comestible from the group consisting of auto-cook, timed, dual-cycle and manual, and applying heat to the comestible for cooking the comestible based on the selection.

In one preferred embodiment, the method also includes applying the thermal probe to the comestible, selecting a first temperature level and a comestible identifier for the comestible, and applying a first level of heat to the comestible using the first temperature level. The method also includes comparing the real-time temperature reading to a predetermined temperature level corresponding to the comestible identifier, applying the first level of heat for a predetermined period of time based on the comparison, counting down the predetermined time, and applying a second level of heat to the comestible less than the first level of heat.

In another preferred embodiment, the method includes selecting a first time and a first temperature level for the comestible, applying a first level of heat representative of the first temperature level to the comestible for the first time, and applying a second level of heat to the comestible less than said first level of heat.

In yet another embodiment, the method includes selecting a first time and a first temperature level for the comestible, selecting a second time and a second temperature level for the comestible subsequent to said first time, and applying a first level of heat to said comestible using said first temperature level for said first time. The method also includes applying a second level of heat to the comestible using the second temperature level for the second time subsequent to the first time, and applying a third level of heat to the comestible less than the first level of heat and the second level of heat.

Additional features and advantages will be readily apparent from the following detailed description, the accompanying drawings and the claims.

### BRIEF DESCRIPTION OF THE DRAWINGS

FIG. 1 is a perspective view of an embodiment of a cooking apparatus according to the present invention.

FIG. 2 is an exploded view of the embodiment shown in FIG. 1.

FIG. 3 shows an alignment of a hinged lid of the present invention.

FIG. 4 is an embodiment of a front panel of a controller according to the present invention.

FIG. 5 shows applying a thermal probe to a comestible according to the present invention.

FIG. 6 is a side perspective view of the hinged lid according to the present invention.

FIGS. 7A and 7B are bottom and top perspective views, respectively, of a first portion of a hinge according to the present invention.

FIGS. 8A and 8B are bottom perspective views of a second portion of a hinge according to the present invention.

FIG. 8C is a top perspective view of the second portion of the hinge shown in FIGS. 8A and 8B.

FIGS. 9A and 9B are top and bottom perspective views, respectively, of a third portion of a hinge according to the present invention.

FIG. 10 is a flow chart of a method executed by the controller upon activation of an auto-cook cooking mode.

FIG. 11 is a flow chart of a method executed by the controller upon activation of a timed cooking mode.

FIG. 12 is a flow chart of a method executed by the controller upon activation of a dual-cycle cooking mode.

FIG. 13 is a flow chart of a method executed by the controller upon activation of a manual cooking mode.

Like reference symbols in the various drawings indicate like elements.

### DETAILED DESCRIPTION OF THE PREFERRED EMBODIMENT

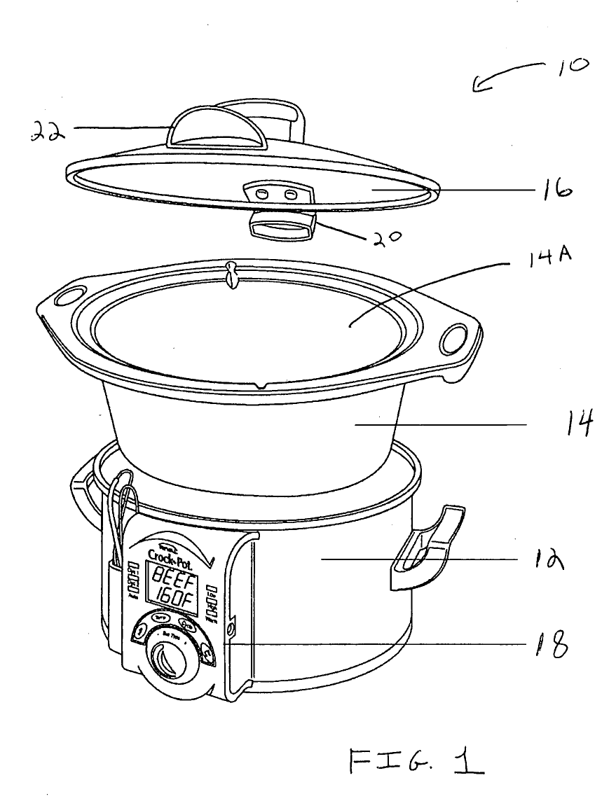

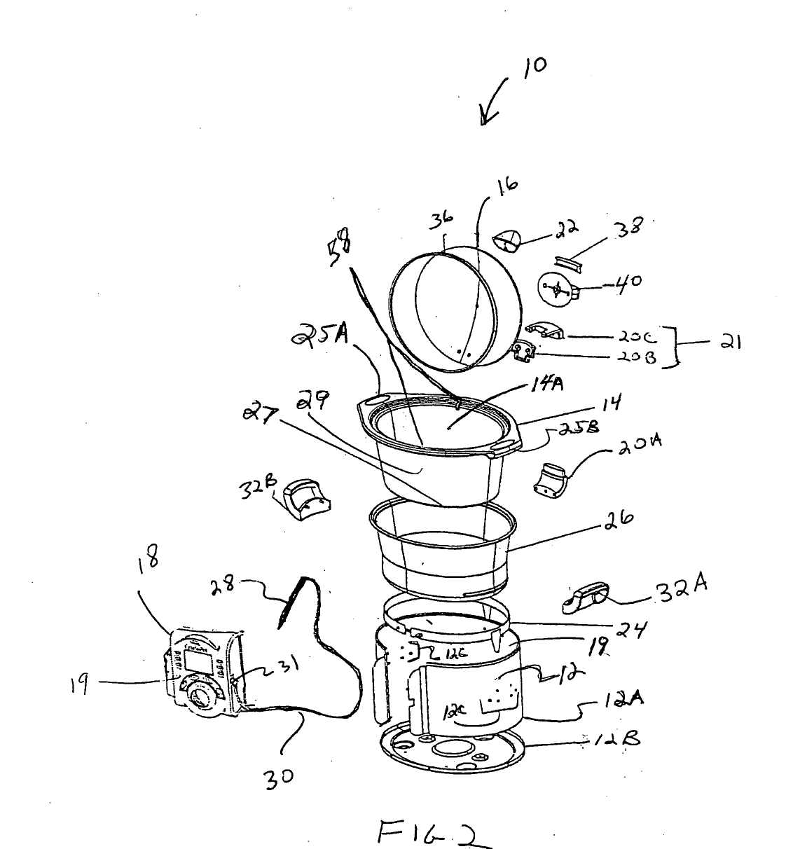

Referring to FIGS. 1 and 2, a cooking apparatus 10, such as a slow-cooker, is disclosed. The cooking apparatus 10 preferably includes a housing 12 and a cooking vessel 14 disposed in the housing 12. The housing 12 preferably includes a bottom portion 12B and a sidewall 12A. The bottom portion 12B and sidewall 12B define a well-like heating chamber 19. Preferably, disposed in the heating chamber 19 is a liner 26 surrounded by a heating element 24 that functions to heat the cooking vessel 14. The liner preferably is made of a heat conducting material such that heat from the heating element is uniformly transferred to the cooking vessel 14.

As shown in FIG. 2, a pair of handle portions 32A and 32B are provided that may be attached to the sidewall 12A via openings 12C using screws (not shown). Of course, it will be appreciated by one skilled in the art that other attachment means may be used to secure handle portions 32A and 32B to the sidewall 12A.

The cooking vessel 14 includes a bottom 27 and a continuous sidewall 29 upstanding from the bottom 27. The cooking vessel 14 is adapted to be at least partially disposed within the liner 26. Preferably, the cooking vessel 14 defines a pair of handle portions 25A and 25B to facilitate lifting the cooking vessel 14 from the housing 12 and one or more grooves or notches 58 on an upper rim of the cooking vessel 14 for receiving a temperature probe cord 30. The cooking vessel 14 is preferably made of ceramic with a coating of conventional glazing compound. The thermal and heat retaining properties of the ceramic cooking vessel 14 allow it to conduct heat from the liner 26 through the sidewall 29. This provides even heating throughout the cooking vessel 14.

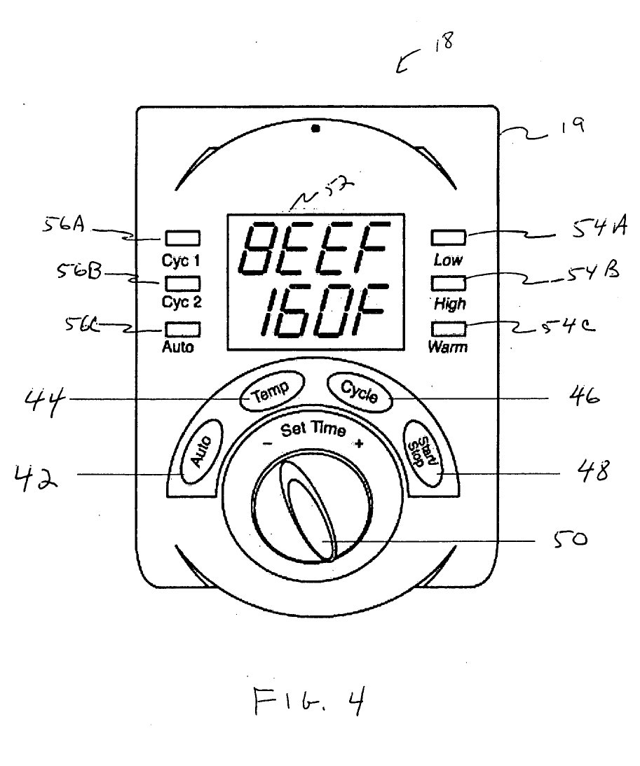

As shown in FIGS. 1 and 2, a controller 18 is provided that is mounted on the housing 12 and is connected to the heating element 24 and directs operation of the heating element 24. In one preferred embodiment, as shown in FIG. 2, the controller 18 may be operatively attached to a thermal probe 28. Preferably, the thermal probe 28 is attached to the temperature probe cord 30 which is inserted into a temperature probe jack 31 of the controller 18. In one preferred embodiment, the controller 18 directs operation of the heating element 24 in response to a real-time temperature reading from the thermal probe 28. Preferably, the thermal probe 28 is adapted to be in thermal communication with a comestible disposed in the cooking vessel 14. Operation of the thermal probe 28 and details of the controller 18 are discussed in connection with FIGS. 4, 5 and 10.

A lid 16 is provided that may be used for covering an opening 14A of the cooking vessel 14. The lid 16 may be made of a transparent material, such as glass or plastic. Preferably, the lid 16 includes a rim 36 surrounding a perimeter of the lid 16 and is made from a metallic material. In operation, the rim 36 serves to protect the perimeter of the lid from damage. The lid 16 also includes a lift 22 for rotating the lid 16 on the cooking vessel, and a handle 40 for attaching and detaching the lid 16 from the cooking vessel 14 by normal vertical lifting motion.

As shown in FIGS. 1 and 2, a hinge 20 removably coupling the lid 16 to the housing 12 is provided. The hinge 20 includes a top mating portion 21 having a generally L-shaped form that extends beyond the perimeter of the lid 16. As shown in FIG. 2, the top mating portion 21 includes a first attachment member 20B and a second attachment member 20C. The top mating portion 21 is removably attached to a bottom mating portion 20A of the apparatus 10.

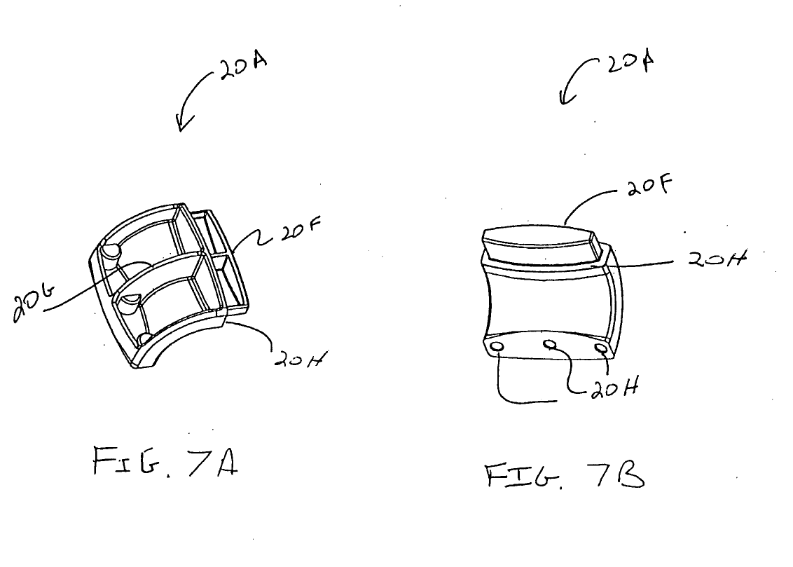

The bottom mating portion 20A of the hinge 20 is shown in FIGS. 7A and 7B. As shown in FIG. 7B, the bottom mating portion 20A is of a generally L-shaped form and includes a plurality of openings 20H that are used to receive fasteners, such as screws or rivets, to secure the bottom mating portion 20A to the sidewall 12A of the housing 12. For example, referring back to FIG. 2, one or more fasteners may be inserted from an inner surface of the sidewall 12A through openings 12C into openings 20H to secure the bottom mating portion 20A to the housing 12. Of course, it will be appreciated by one skilled in the art, other conventional techniques may be used to secure the bottom mating portion 20A to the housing 12. Preferably, when the bottom mating portion 20A is secured to the housing 12, the bottom mating portion 20A extends outwardly and upwardly from the housing 12.

In one preferred embodiment, referring back to FIGS. 7A and 7B, the bottom mating portion 20A includes an extending top member 20F having a dimension slightly less than that of the bottom mating portion 20A to form a ledge 20H for supporting top mating portion 21. As shown in FIG. 7A, ribs 20G also may be provided that add additional support for the hinge 20. The top member 20F is used to demountably couple the bottom mating portion 20A to the second attachment member 20C of the top mating portion 21.

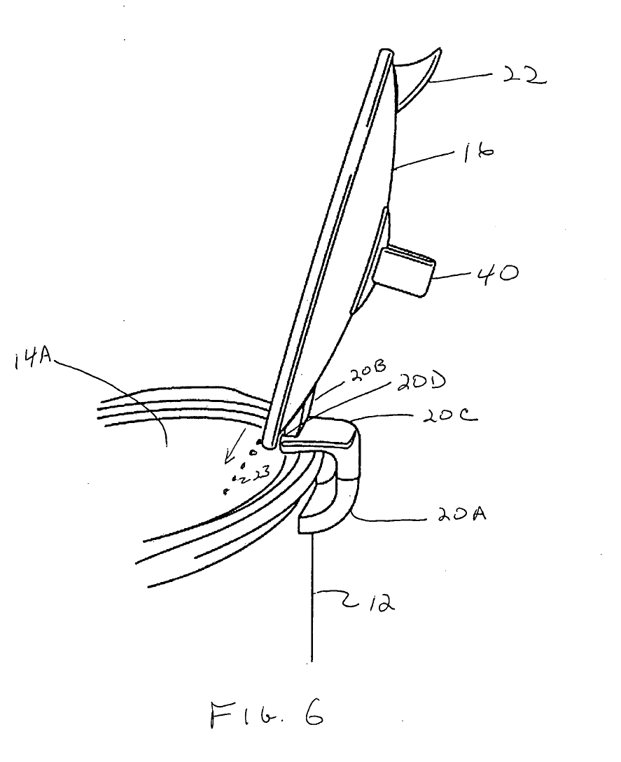

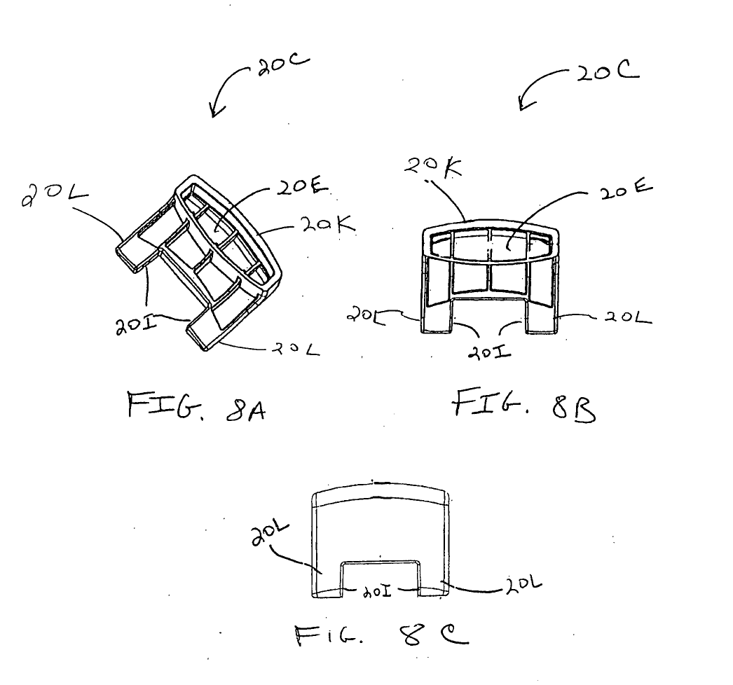

Referring now to FIGS. 8A-8C, the second attachment member 20C is a generally planar member having a body formed with two generally parallel arms 20L, each of which includes an opening 201 opposed to each other for receipt of a pivot member, such as a pin. As shown in FIGS. 8A and 8B, the second attachment member 20C also includes a wall 20K defining a cavity 20E having dimensions suitable for insertion of the top member 20F of the bottom mating portion 20A. Insertion of the top member 20F into the cavity 20E, as shown in FIG. 6, results in a generally U-shaped hinge 20 with the top mating portion 21 being removably coupled to the bottom mating portion 20A.

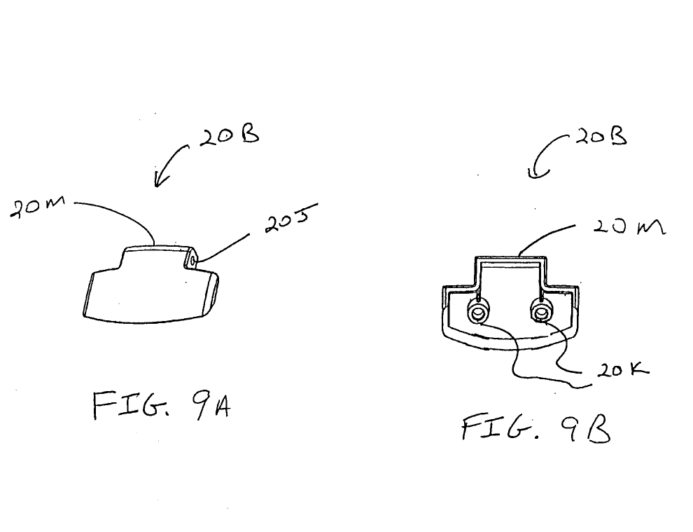

Referring now to FIGS. 9A and 9B, the first attachment member 20B is preferably a generally planar member that is coupled to the lid. For example, in one preferred embodiment, as shown in FIG. 9B, the first attachment member 20B includes two raised bosses 20K that are adapted to each receive a screw for securing the member 20B to the lid 16. The first attachment member also includes a tab member 20M having a reduced dimension which fits between arms 20L and openings 20J that is aligned with openings 201 for receipt of the pivot member.

Receipt of a pivot member into openings 20J and 201 allows the first attachment member 20B to be pivotally attached to the second attachment member 20C at a pivot point 20D, thereby, allowing the lid 16 to be pivoted with respect to the second attachment member 20C. When the top member portion 21 is attached to the bottom member portion 20A, the lid 16 may be pivoted between an open position and a closed position. In one preferred embodiment, referring to FIG. 6, when the lid 16 is moved to the open position, a portion of the lid adjacent to the cooking vessel opening 14A is disposed over the cooking vessel opening 14A. Fluid on the inner surface of the lid 16, such as condensation or comestible matter resulting from cooking a comestible, is thereby directed back into the cooking vessel opening 14A. In one preferred embodiment, the pivot point 20D of the hinge 20 is disposed over the cooking vessel opening 14A.

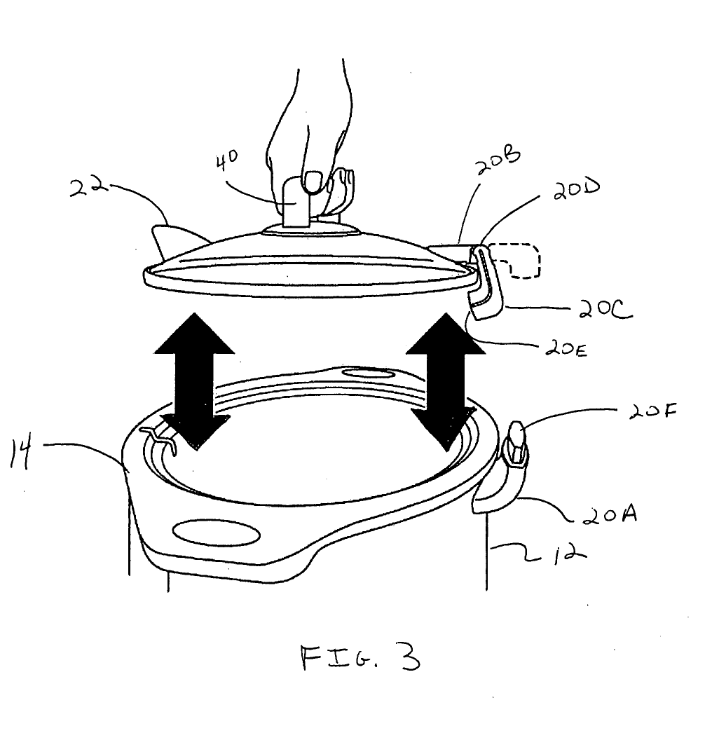

Referring now to FIG. 3, removing and attaching the lid 16 using the hinge 20 is explained. Preferably, the lid 16 is removably attached to the housing by lowering the lid horizontally down onto the cooking vessel 14. As shown in FIG. 3, the second attachment member 20C is aligned to receive the top member 20F of the bottom mating portion 20A in the cavity 20E. Removing the lid 16 is accomplished by lifting the lid 16 horizontally off the cooking vessel 14 and thereby, lifting the cavity 20E away from the top member 20F. The hinge 20 permits the lid 16 to be rotated and removed which provides flexibility in cooking and cleaning of the apparatus 10.

Referring back to FIG. 2, the controller 18 allows the user of the apparatus 10 to electronically control and program cooking cycles and temperature. The controller 18 preferably includes electronic components, such as a circuit board, for storing and controlling cooking functions and variables, and a control panel 19 that are assembled together for attachment to the outer sidewall 12A of the housing 12. In use, the heating element 24 of the present invention is energized as necessary by the controller 18 to supply heat at a maintained temperature to the cooking vessel 14.

In one preferred embodiment, the controller 18 of the present invention provides four cooking modes. The cooking modes include 1) an auto-cook mode that cooks a comestible using the temperature probe 28 and is based on both temperature and time-settings, 2) a timed mode that allows the user to set a time and temperature at which the comestible is to be cooked, 3) a dual-cycle mode that allows the user to set one temperature for a specified time and then automatically switch to another temperature for additional time set by the user, and 4) a manual mode that allows the user to select a temperature to cook the comestible until the temperature is switched to another temperature level or powered off. Selection of a cooking mode by the user is accomplished via the control panel 19.

An exemplary control panel 19 is shown in FIG. 4. The control panel 19 includes a plurality of indicator lights, such as light-emitting diodes “LEDs” 56A-C, that indicate selections for a cooking mode and status indicators of a cooking mode. As shown in FIG. 4, other LEDs 54A-C are provided that indicate the level of heat being applied to the comestible during a cooking mode. For example, as shown in FIG. 4, a LOW LED 54A, a HIGH LED 54B and a WARM LED 54C may be illuminated depending upon either the level of heat being applied to the comestible at a particular point in time during a cooking mode or to be applied for a particular cooking mode. As is well-known in the art, a variety of other indicator devices may be provided, including audible alarms, incandescent lamps or fluorescent readouts.

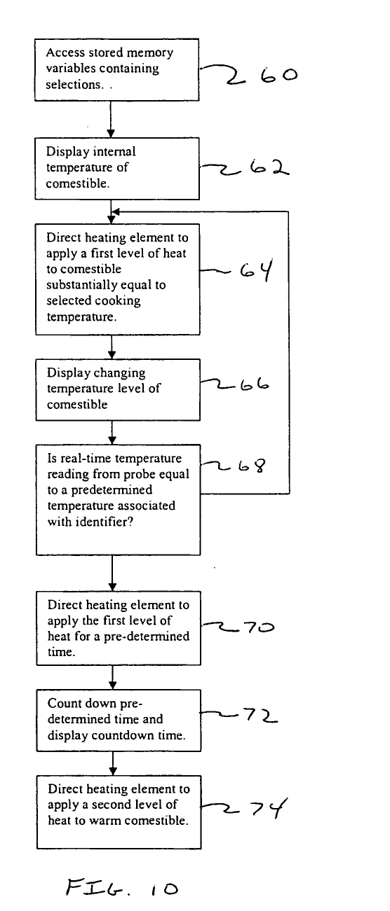

In one preferred embodiment, the control panel 19 includes a display 52 that also can be used to relay cooking status information from the controller 18 to the user. For example, as shown in FIG. 4, the controller may display a real-time temperature level of a comestible and a type of comestible being cooked upon selection of the auto-cook cooking mode. The types of information displayed by the controller 18 on the display 52 are discussed in connection with FIG. 10 and operation of the invention.

As shown in FIG. 4, the control panel includes a timer-dial 50 that allows the user to select cooking times to apply heat during a cooking mode. For example, in one preferred embodiment, the timer-dial 50 allows the user to select a cooking time from thirty (30) minutes to twenty (20) hours in 30 minute increments. Of course, it will be appreciated by one skilled in the art, the present invention is not limited to twenty (20) hours or thirty (30) minute increments, and that other time increments are within the scope of the present invention.

An auto-cook button 42 is provided that, upon selection, allows the user to identify the type of comestible (i.e., a comestible identifier) that is to be cooked using the auto-cook mode. In one preferred embodiment, for example, the comestible identifiers are pre-defined by the controller and include “BEEF”, “POULTRY”, “PORK”, “STEW”, and “CHILI”. Selection of a comestible identifier by the user allows the controller to determine the amount of time a level of heat is to be applied to the comestible to achieve optimal flavor.

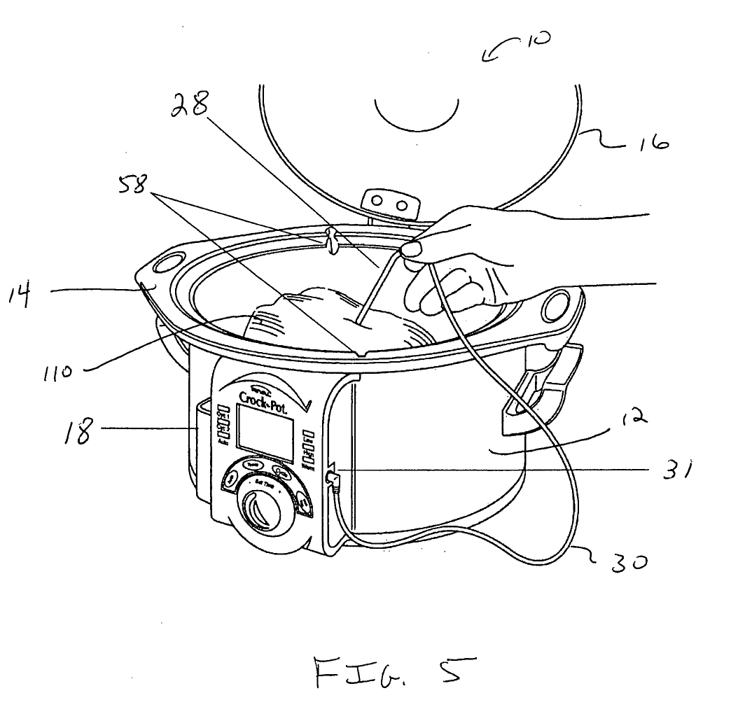

Referring now to FIG. 5, operation of the auto-cook mode is described. As shown in FIG. 5, the cooking vessel 14 is disposed in the housing 12 and contains a comestible 110. The apparatus 10 of the present invention is then activated upon plugging the apparatus 10 into a conventional electrical outlet. Next, the thermal probe of the invention is in applied to the comestible 110. For example, as shown in FIG. 5, the thermal probe 28 may be inserted into a center of the comestible 110 or center of the cooking vessel 14. Plugging the probe 28 into the controller 18 signals to the controller 18 that the auto-cook mode has been selected. The user plugs the temperature probe cord 30 into the temperature probe jack 31 of the controller 18. The lid 16 of the apparatus 10 then may be attached to the housing 12, as described previously, and the temperature probe cord 30 is set in one of the notches 58 of the cooking vessel 14 under the lid 16. In one preferred embodiment, if the temperature probe cord 30 is pulled out of the jack 30 while the apparatus 10 is plugged into the electrical outlet, the controller 18 notifies the user via an audio signal and displays “TEMP OUT” on the display 52 of the control panel 19. With the probe 28 plugged into the controller 18, user selection of the auto-cook button 42 cycles through comestible identifiers. Upon selection of a comestible identifier, the controller 18 stores the comestible identifier selection in a variable on the circuit board. Next, the user selects the temp button 44 to select either a pre-set HIGH cooking temperature or a pre-set LOW cooking temperature for the comestible 110. Upon selection, the controller 18 stores the selected cooking temperature (e.g., HIGH or LOW) in a variable on the circuit board. Next the user selects the start-stop button which results in the controller 18 activating the auto-cook cooking mode.

Referring now to FIG. 10, upon activation of the auto-cook mode, the controller 18 accesses the stored memory variables containing the selections 60 and displays the internal temperature 62 of the comestible 110 on the display 52 of the control panel 19. Preferably, the controller 18 illuminates one of the temperature LED lights 54A or 54B based on the selection. Next, the controller 18 directs the heating element 24 to apply a first level of heat to the comestible substantially equal to the selected cooking temperature 64. Preferably, the controller 18 displays a heat level of the comestible as it changes in response to the heating element applying the level of heat 66. The controller 18 compares the real-time temperature readings of the comestible received from the probe 28 to a predetermined temperature level associated with the selected comestible identifier 68. Preferably, the predetermined temperature level and a predetermined cook time are initially stored for each constable identifier on the circuit board. The heating element 24 continues to apply the same level of heat to the comestible until the predetermined temperature is reached. Upon the controller 18 determining that the internal temperature of the comestible 110 has reached the predetermined temperature, the controller 18 directs the heating element 24 to apply the same level of heat for a predetermined period of time 70. The predetermined period of time depends on the comestible identifier selected and the temperature level selected by the user. The controller 18 then counts down the predetermined time 72 and preferably displays the count down time on the display 54. At this point, the controller 18 directs the heating element 24 to apply this same level of heat to the comestible until the comestible reaches its optimal flavor. At which point, the cooking of the comestible is complete. Accordingly, in order to achieve optimal comestible flavor in auto-cook mode, a user simply needs to select the type of comestible identifier.

Upon the predetermined time expiring, in one preferred embodiment, the controller 18 sends an audio signal to the user and directs the heating element 24 to apply a second level of heat to 74 maintain warmth of the comestible 110. The second level of heat being less than the first level of heat applied to the comestible. The temperature level in this warming stage is preferably warm enough to maintain the food in a safe manner yet does not continue to cook the food. The warmth may be maintained until the user turns off the apparatus 10 via the start-stop button 48 or activates a cooking cycle. Alternatively, upon the predetermined time expiring, the heating element may be turned off.

In an alternative embodiment, once the predetermined temperature level is achieved, the controller directs the heating element to maintain warmth of the comestible without counting down a predetermined time. In yet another embodiment, once the predetermined temperature level is reached, power to the heating element is terminated.

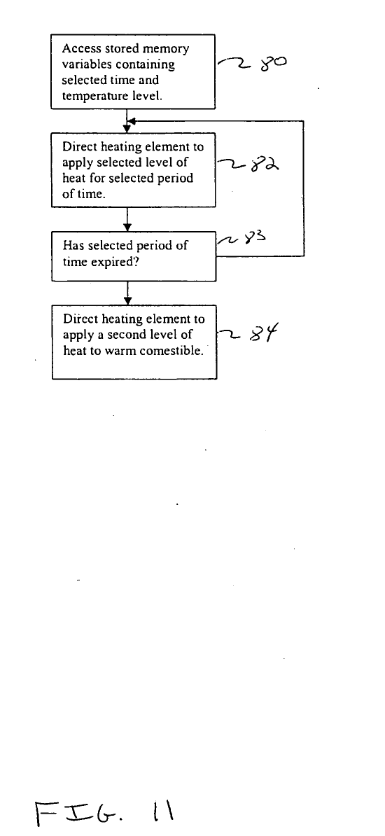

Referring now to FIGS. 4 and 11, the timed cooking mode allows the user to set a time and temperature at which to cook a comestible. First, similar to the auto-cook mode, a comestible contained in the cooking vessel 14 is disposed in the housing 12. Next, the lid may be attached to the housing 12 and the apparatus 10 is plugged into a standard electrical outlet. The user then selects the temp button 44 to select a HIGH or LOW cooking temperature. In one preferred embodiment, upon selection of a cooking temperature by the user, either the HIGH LED 56B or LOW LED 56A is illuminated on the control panel 19 by the controller 18. Next, the user selects the amount of time to cook the comestible by turning the timer-dial 50 to a selected time. The controller stores the selected time and temperature level in memory variables on the circuit board. Next, the user selects the start-stop button 48 which causes the controller 18 to activate the timed mode. The heating element 24 is energized to the selected cooking temperature for the selected time.

As shown in FIG. 11, the controller 18 accesses the memory variables containing the selected time and temperature level 80. Next, the controller 18 directs the heating element 24 to apply a level of heat substantially equal to the selected level of heat for the selected period of time 82. The controller 18 then determines whether the selected period of time has expired 83. Once the selected time expires, in one preferred embodiment, the controller sends an audio signal to the user and directs the heating element 24 to apply a second level of heat to the controller 18 to maintain the comestible at a warm level 84. The user may then select the start-stop button 48 to turn off the apparatus 10.

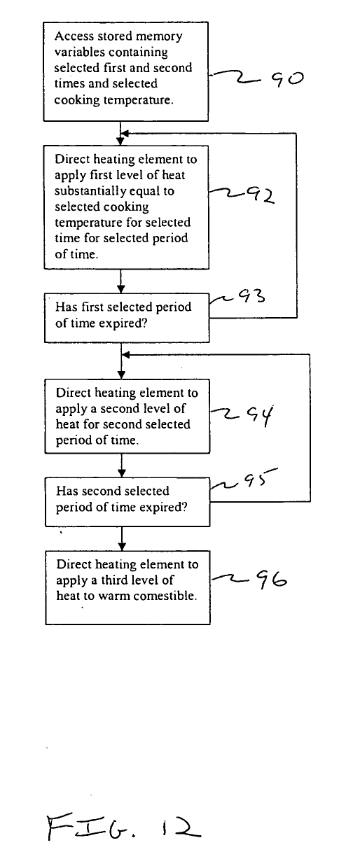

Referring now to FIGS. 4 and 12, the dual-cycle cooking mode operates similar to the timed mode. The dual-cycle mode, however, allows the user to set one cooking temperature for a specified period of time and then automatically switches to another cooking temperature for another user specified time. For example, upon the user disposing the cooking vessel containing a comestible in the housing 12, as explained previously, the user selects the temp button 44 on the control panel 19 to select a LOW or HIGH cooking temperature. In one preferred embodiment, the controller 18 illuminates the HIGH LED 54B or LOW LED 54A on the panel 19 and stores the temperature selection in a memory variable on the circuit board. Next, the user selects a first amount of time by rotating the timer-dial 50 in either a clockwise or counter-clockwise direction. The controller then stores the selected time in a memory variable on the circuit board. The user then selects the cycle button 46 at which time, in one preferred embodiment, the controller 18 illuminates the other temperature LED. Next, the user selects a second cook time for cooking the comestible, which, upon selection, is stored by the controller in a variable on the circuit board. Upon selecting the start-stop button 48 by the user, the controller 18 activates the dual-cycle cooking mode.

As shown in FIG. 12, upon activation of the dual-cycle mode, the controller 18 accesses the selected first and second times and first cooking temperature from the memory variables stored on the circuit board 90. Next, the controller directs the heating element 24 to apply a first level of heat substantially equal to the first cooking temperature to the comestible for the first selected time 92. Next, the controller 18 determines whether the first selected time has expired 93. Upon expiration of the first selected time, the controller directs the heating element 24 to apply a second level of heat to the comestible for the second selected time 94. For example, after applying a level of heat to the comestible substantially equal to a HIGH cooking temperature selection for the first period of time, the controller 18 directs the heating element 24 to apply a level of heat to the comestible substantially equal to the LOW cooking temperature for the second selected period of time. Likewise, upon applying a LOW cooking temperature to the comestible for the first time selected, the controller 18 directs the heating element 24 to apply a second level of heat to the comestible substantially equal to the HIGH cooking temperature for the second selected period of time. Upon expiration of the second selected period of time, the controller 18 directs the heating element 24 to provide a third level of heat to the comestible to maintain the comestible at a warm level 96. Preferably, the third level of heat is less than the first level and second level of heat.

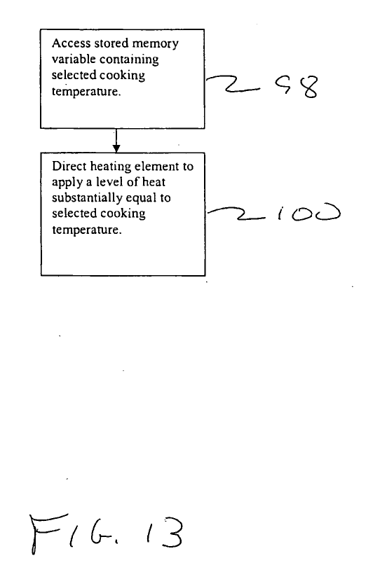

Referring now to FIGS. 4 and 13, the manual cook mode allows the user to set a temperature and the controller 18 directs the heating element 24 to apply a level of heat substantially equal to the selected temperature level until a different temperature level is selected or the apparatus 10 is turned off. For example, first the user disposes the cooking vessel containing a comestible in the housing 12 as described previously. Next, the user selects the temp button 44 to select either a HIGH or LOW cooking temperature. Upon selection of the temperature level, the controller 18 stores the temperature level in a memory variable of the circuit board. Next, upon the user selecting the start-stop button 48, the controller 18 activates the manual cooking mode and cooks the comestible at the selected level until the apparatus 10 is powered off by the user.

As shown in FIG. 13, the controller accesses the memory variable storing the temperature level from the circuit board 98 and directs the heating element 24 to apply a level of heat to the cooking vessel substantially equal to the temperature level selected by the user 100. In one preferred embodiment, to change the temperature level selected after activation of the manual cooking mode, the user can select the start-stop button 48, select a different temperature level, and restart the manual mode by selecting the start-stop button.

In the preferred embodiment, the controller permits the user to switch between cooking modes. For example, when in the manual mode, a user actuating the timer-dial 50 and setting a cooking time cooks the comestible in the timer mode.

In any of the disclosed cooking modes, the temperature level may be controlled by changing the duty cycle of the heating element in a manner known in the art. The warming time may be controlled by way of a temperature sensing element (not shown) in thermal communication with the liner 26. The temperature sensing element is operably coupled to the controller 18. The heating element is cycled on and off maintaining a desired warm temperature for the comestible.

Although preferred embodiments of the present invention have been described herein with reference to the accompanying drawings, it is to be understood that the invention is not limited to those precise embodiments and that various other changes and modifications may be affected herein by one skilled in the art without departing from the scope or spirit of the invention, and that it is intended to claim all such changes and modifications that fall within the scope of the invention.

1. A method of cooking a comestible in a multi-mode slow cooker comprising:
providing a thermal probe attached to a slow cooker for a real-time temperature reading of a comestible disposed in a cooking vessel of said slow cooker;
selecting a cooking mode for said comestible from the group consisting of auto-cook, timed, dual-cycle and manual; and
applying heat to said comestible for cooking said comestible based on the selection.

2. The method of claim 1, wherein selecting the auto-cook mode comprises:
applying said thermal probe to said comestible;
selecting a first cooking temperature;
selecting a comestible identifier for said comestible;
applying a first level of heat to said comestible using said first cooking temperature;
comparing said real-time temperature reading to a predetermined temperature corresponding to said comestible identifier;
applying said first level of heat for a predetermined period of time based on the comparison;
counting down said predetermined time; and
applying a second level of heat to said comestible, said second level of heat less than said first level of heat.

3. The method of claim 2, wherein selecting said comestible identifier comprises selecting from the group consisting essentially of pork, poultry, beef, stew and chili.

4. The method of claim 2, wherein selecting said first cooking temperature comprises selecting from the group consisting of high and low.

5. The method of claim 2, further comprising providing a display for displaying said real-time temperature reading.

6. The method of claim 5, further comprising displaying said counting down of said predetermined time on a display.

7. The method of claim 2, further comprising providing a signal when said real-time temperature reading is substantially equal to said predetermined temperature.

8. The method of claim 1, wherein the timed mode comprises:
selecting a first time and a first cooking temperature for said comestible;
applying a first level of heat of heat representative of said first cooking temperature to said comestible for said first time; and
applying a second level of heat to said comestible, said second level of heat less than said first level of heat.

9. The method of claim 8, wherein selecting said first time comprises selecting said first time in predetermined increments.

10. The method of claim 8, comprising providing a signal upon passage of said first time.

11. The method of claim 1, wherein the dual-cycle mode comprises:
selecting a first time and a first cooking temperature for said comestible;
selecting a second time for said comestible subsequent to said first time;
applying a first level of heat to said comestible using said first cooking temperature for said first time;
applying a second level of heat to said comestible for said second time subsequent to said first time, said second level of heat different from said first level of heat; and
applying a third level of heat to said comestible less than said first level of heat and said second level of heat.

12. The method of claim 11, comprising providing a signal to a user upon passage of said first time.

13. The method of claim 11, comprising providing a signal to a user upon passage of said second time.

14. The method of claim 1, wherein the manual mode comprises:
selecting a cooking temperature for cooking a comestible; and
applying a level of heat to said comestible representative of said cooking temperature.

15. A cooking apparatus comprising:
a lid;
a housing;
a cooking vessel disposed in said housing, said cooking vessel having a perimeter defining an opening; and
a hinge removably coupling said lid to said housing, said hinge allowing said lid to be pivoted between a first open position and a second closed position whereupon movement of said lid to said first open position allows fluid on an inner surface of said lid to be directed into said cooking vessel opening.

16. The cooking apparatus of claim 15, wherein movement of said lid to said first open position causes a portion of said lid to be disposed over said cooking vessel opening.

17. The cooking apparatus of claim 15, wherein movement of said lid to said first open position causes said lid to be pivoted above said cooking vessel opening.

18. The cooking apparatus of claim 15, wherein said hinge comprises a top mating portion coupled to said lid and a bottom mating portion coupled to said housing, said top mating portion and said bottom mating portion detachably coupled.

19. The cooking apparatus of claim 18, wherein said top mating portion comprises a cavity having dimensions suitable for insertion of said bottom mating portion.

20. The cooking apparatus of claim 18, wherein said top mating portion comprises a first attachment coupled to said lid, said first attachment pivotally attached to a second attachment allowing said lid to be pivoted between said first open position and said second closed position.

21. A cooking apparatus comprising:
a thermal probe;
a housing;
a cooking vessel disposed in said housing;
a heating element disposed in said housing; and
a controller attached to said housing and operably connected to said heating element for controlling operation of said heating element in response to a real-time reading from said thermal probe, said thermal probe operatively connected to said controller and adapted to be in thermal communication with a comestible disposed in said cooking vessel.

22. The cooking apparatus of claim 21 further comprising a lid.

23. The cooking apparatus of claim 21, wherein said controller controls a plurality of levels of heat.

24. The cooking apparatus of claim 23, wherein said controller controls at least one time of heat for at least one of said plurality of levels of heat.

25. The cooking apparatus of claim 21, wherein said cooking vessel comprises at least one notch for insertion of said thermal probe into said cooking vessel.

26. The cooking apparatus of claim 21, wherein said thermal probe is removably coupled to said controller.

27. The cooking apparatus of claim 21, further comprising a hinge removable coupling said lid to said housing, said hinge allowing said lid to be pivoted between a first open position and a second closed position whereupon movement of said lid to said first open position allows fluid on an inner surface of said lid to be directed into said cooking vessel opening.

28. A multi-functional programmable cooker comprising:
a housing;
a thermal probe;
a heating element disposed in said housing;
a cooking vessel disposed in said housing and adapted to contain a comestible; and
a controller operable coupled to said heating element to provide a plurality of cooking modes including a first mode, wherein connection of said probe to said controller selects automatically said first mode from said plurality of cooking modes and said comestible is subject to heat which is controllable by said controller in response to a real-time temperature reading from said thermal probe.

29. The multi-functional programmable cooker of claim 28, wherein said controller is responsive to a comestible identifier selection.

30. The multi-functional programmable cooker of claim 29, wherein said controller compares said real-time temperature reading to a predetermined temperature corresponding to said comestible identifier.

31. The multi-functional programmable cooker of claim 30, wherein said controller directs said heating element to apply a first level of heat for a predetermined period of time based on the comparison.

32. The multi-functional programmable cooker of claim 30, wherein upon a countdown of said predetermined time by said controller, said controller directs said heating element to apply a second level of heat to said comestible, said second level of heat less than said first level of heat.

33. The multi-functional programmable cooker of claim 28, wherein said plurality of cooking modes includes a second mode, wherein said controller directs said heating element to apply a first level of heat representative of a first cooking temperature to said comestible for a first time in response to a selection of said first time and said first cooking temperature.

34. The multi-functional programmable cooker of claim 28, wherein said plurality of cooking modes includes a third mode, wherein said controller directs said heating element to apply a first level of heat to said comestible using a first cooking temperature for a first time in response to a selection of said first time and said first cooking temperature, wherein said controller subsequently directs said heating element to apply a second level of heat to said comestible for a second time, selected subsequent to said first time, wherein said controller subsequently directs said heating element to apply a third level of heat to said comestible less than said first level of heat and said second level of heat.

35. The multi-functional programmable cooker of claim 28, wherein said plurality of cooking modes includes a fourth mode, wherein said controller directs said heating element to apply a level of heat to said comestible in response to a cooking temperature selection.

36. A method of cooking a comestible in a multi-functional programmable cooker comprising:
providing a thermal probe for attachment to a controller, said controller providing a plurality of cooking modes for cooking a comestible;
providing a heating element disposed in a housing, said heating element coupled to said controller;
providing a cooking vessel disposed in said housing and adapted to contain said comestible; and
selecting automatically a first cooking mode from said plurality of cooking modes upon operatively connecting said thermal probe to said controller, said controller operatively controlling heat provided by said heating element in response to a real-time temperature reading from said thermal probe.
